(19) United States
(12) Patent Application Publication
(10) Pub. No.: US 2016/0100354 A1
(43) Pub. Date: Apr. 7, 2016

(54) TERMINAL DEVICE, COMMUNICATION SYSTEM, AND METHOD IMPLEMENTED BY THE TERMINAL DEVICE

(71) Applicant: Haruomi HIGASHI, Kanagawa (JP)

(72) Inventor: Haruomi HIGASHI, Kanagawa (JP)

(21) Appl. No.: 14/873,655

(22) Filed: Oct. 2, 2015

(30) Foreign Application Priority Data
Oct. 7, 2014 (JP) 2014-206469

(51) Int. Cl. H04W 48/16; H04W 4/02

(52) U.S. Cl. CPC H04W 48/16; H04W 4/021; H04W 4/025

(57) ABSTRACT

A terminal device that is carried by a user and is connected to a network by wireless communication, the terminal device comprises: a communication unit that communicates information with some other device via the network in a communication form selected from multiple communication forms; an acquiring unit that acquires a communication-enabled place where the terminal device can communicate information in any of the communication forms in a peripheral area of a current location of the terminal device and a data transfer rate when the terminal device performs wireless communication in the communication-enabled place; a generating unit that generates available information indicating whether the communication forms are available on the basis of a corresponding data transfer rate with respect to each communication-enabled place in the peripheral area; and a presenting unit that presents the available information in each communication-enabled place in the peripheral area to the user.

### CROSS-REFERENCE TO RELATED APPLICATIONS

The present application claims priority to and incorporates by reference the entire contents of Japanese Patent Application No. 2014-206469 filed in Japan on Oct. 7, 2014.

### BACKGROUND OF THE INVENTION

1. Field of the Invention

The present invention relates to a terminal device, a communication system, and a method implemented by the terminal device.

2. Description of the Related Art

Terminal devices such as smartphones can communicate information in various forms of communication, such as voice call, text communication, and video conference. Furthermore, there is known a system that provides a stable communication-enabled place to a terminal device (for example, see Japanese Patent Application Laid-open No. 2014-45450).

Incidentally, terminal devices vary in required data transfer rate according to the communication form. For example, a higher data transfer rate is required of a terminal device when having a video conference than when communicating a text. However, the terminal device cannot communicate at an enough data transfer rate to have a video conference in all places. Therefore, when a user wants to communicate information in a communication form such as video conference that requires a high data transfer rate, the user has to move to a place where communication can be performed at the required data transfer rate.

In view of the above, there is a need to provide a terminal device, communication system, and method capable of presenting where to move to so as to communicate information in an intended communication form to a user.

### SUMMARY OF THE INVENTION

According to the present invention, there is provided a terminal device that is carried by a user and is connected to a network by wireless communication, the terminal device comprising: a communication unit that communicates information with some other device via the network in a communication form selected from multiple communication forms; an acquiring unit that acquires a communication-enabled place where the terminal device can communicate information in any of the communication forms in a peripheral area of a current location of the terminal device and a data transfer rate when the terminal device performs wireless communication in the communication-enabled place; a generating unit that generates available information indicating whether the communication forms are available on the basis of a corresponding data transfer rate with respect to each communication-enabled place in the peripheral area; and a presenting unit that presents the available information in each communication-enabled place in the peripheral area to the user.

The present invention also provides a communication system comprising: a first terminal device that is carried by a first user and is connected to a network by wireless communication; a second terminal device that is used by a second user who is a partner for communication with the first user; and a sever device that is accessed by the first terminal device via the network, wherein the first terminal device includes: a communication unit that communicates information with the second terminal device via the network in a communication form selected from multiple communication forms; an acquiring unit that acquires a communication-enabled place where the first terminal device can communicate information in any of the communication forms in a peripheral area of a current location of the first terminal device and a data transfer rate when the first terminal device performs wireless communication in the communication-enabled place; a generating unit that generates available information indicating whether the communication forms are available on the basis of a corresponding data transfer rate with respect to each communication-enabled place in the peripheral area; and a presenting unit that presents the available information in each communication-enabled place in the peripheral area to the user.

The present invention also provides a method implemented by a terminal device that is carried by a user and is connected to a network by wireless communication, the terminal device being capable of communicating information with some other device via the network in a communication form selected from multiple communication forms, the method comprising: acquiring a communication-enabled place where the terminal device can communicate information in any of the communication forms in a peripheral area of a current location of the terminal device and a data transfer rate when the terminal device performs wireless communication in the communication-enabled place; generating available information indicating whether the communication forms are available on the basis of a corresponding data transfer rate with respect to each communication-enabled place in the peripheral area; and presenting the available information in each communication-enabled place in the peripheral area to the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a communication system according to a first embodiment of the present invention;

FIG. 2 is a diagram illustrating block configurations of a first terminal device according to the first embodiment and a sever device;

FIG. 3 is a diagram illustrating an example of a table showing place information and data transfer rate in the place;

FIG. 4 is a diagram illustrating an example of a correspondence relation between a value of data transfer rate and level;

FIG. 5 is a diagram illustrating an example of available information;

FIG. 6 is a diagram illustrating an example of available information with respect to each of the current location and communication-enabled places in a peripheral area;

FIG. 7 is a flowchart illustrating a process performed by the first terminal device according to the first embodiment;

FIG. 8 is a diagram illustrating an example of display on the first terminal device according to the first embodiment;

FIG. 9 is a diagram illustrating a display example of a balloon further including security level and a communication fee;

FIG. 10 is a diagram illustrating a communication system according to a second embodiment of the present invention;

FIG. 11 is a diagram illustrating block configurations of a first terminal device according to the second embodiment and the sever device;

FIG. 12 is a diagram illustrating an example of display on the first terminal device according to the second embodiment;

FIG. 13 is a flowchart illustrating a process performed by the first and second terminal devices according to the second embodiment; and

FIG. 14 is a diagram illustrating an example of a hardware configuration of the first terminal device.

### DETAILED DESCRIPTION OF THE PREFERRED EMBODIMENTS

A communication system 10 according to an embodiment of the present invention is explained in detail below with reference to accompanying drawings. The communication system 10 allows for communication of information in multiple communication forms, and further can present where to move to so as to communicate information in an intended communication form to a user.

### First Embodiment

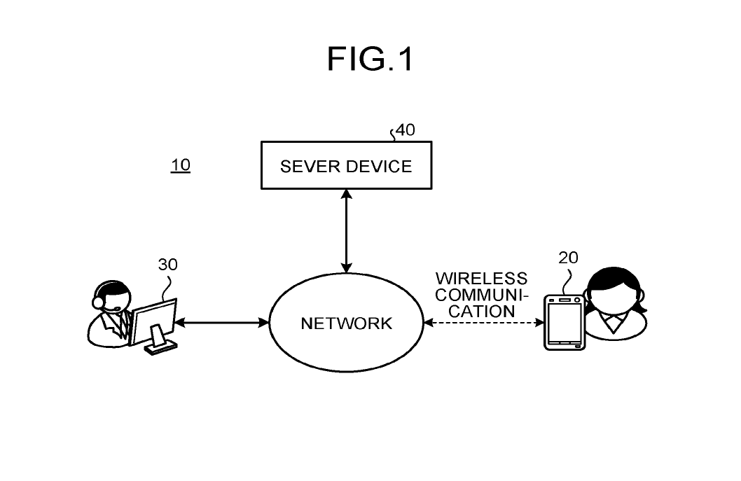

FIG. 1 is a diagram showing a communication system 10 according to a first embodiment of the present invention. The communication system 10 includes a first terminal device 20, a second terminal device 30, and a sever device 40. The first terminal device 20, the second terminal device 30, and the sever device 40 communicate information with one another via a network. The network is a public network such as the Internet as an example.

The first terminal device 20 is a small-sized information processing apparatus carried by a first user. The first terminal device 20 is a device having a data input function, a data presentation function (for example, a display function), and a communication function. As an example, the first terminal device 20 is a smartphone, a tablet, a cell-phone, or the like.

The first terminal device 20 is connected to the network by wireless communication such as Wi-Fi™ (Wireless Fidelity). Alternatively, the first terminal device 20 can be connected to the network by wireless communication complying with mobile communication standards such as LTE (Long Term Evolution). Furthermore, the first terminal device 20 can be connected to the network by any wireless communication by switching among multiple mobile communication standards.

The second terminal device 30 is an information processing apparatus (the other device) used by a second user who communicates with the first user. The second terminal device 30 is a device having a data input function, a data presentation function (for example, a display function), and a communication function. In the present embodiment, the second terminal device 30 can be a non-portable type information processing apparatus. Furthermore, in the present embodiment, the second terminal device 30 can be connected to the network by wire communication.

The sever device 40 is an information processing apparatus connected to the network. The sever device 40 is accessed by the first terminal device 20 and the second terminal device 30 via the network, and transmit requested information to the first terminal device 20 and the second terminal device 30.

In this communication system 10, the first terminal device 20 and the second terminal device 30 communicate information in a communication form selected from multiple communication forms. The communication forms are forms of communication of information exchanged among multiple users via a network. In the present embodiment, the communication forms include communication of information using text (in the present embodiment, referred to as chat), communication of information using voice (in the present embodiment, referred to as IP telephony), and communication of information using moving image (in the present embodiment, referred to as video conference).

The communication system 10 causes the first user using the first terminal device 20 and the second user using the second terminal device 30 to select any one of the communication forms.

Furthermore, in the communication system 10, the first terminal device 20 presents information indicating where to move to so as to communicate information using an intended communication form to the first user. For example, the first terminal device 20 displays places where a user can chat, places where a user can make an IP telephony call, and places where a user can have a video conference on a map showing a peripheral area of the current location. Accordingly, even when the first user using the first terminal device 20 cannot use an intended communication form in the current location, the first user can efficiently move to a place available for the intended communication form.

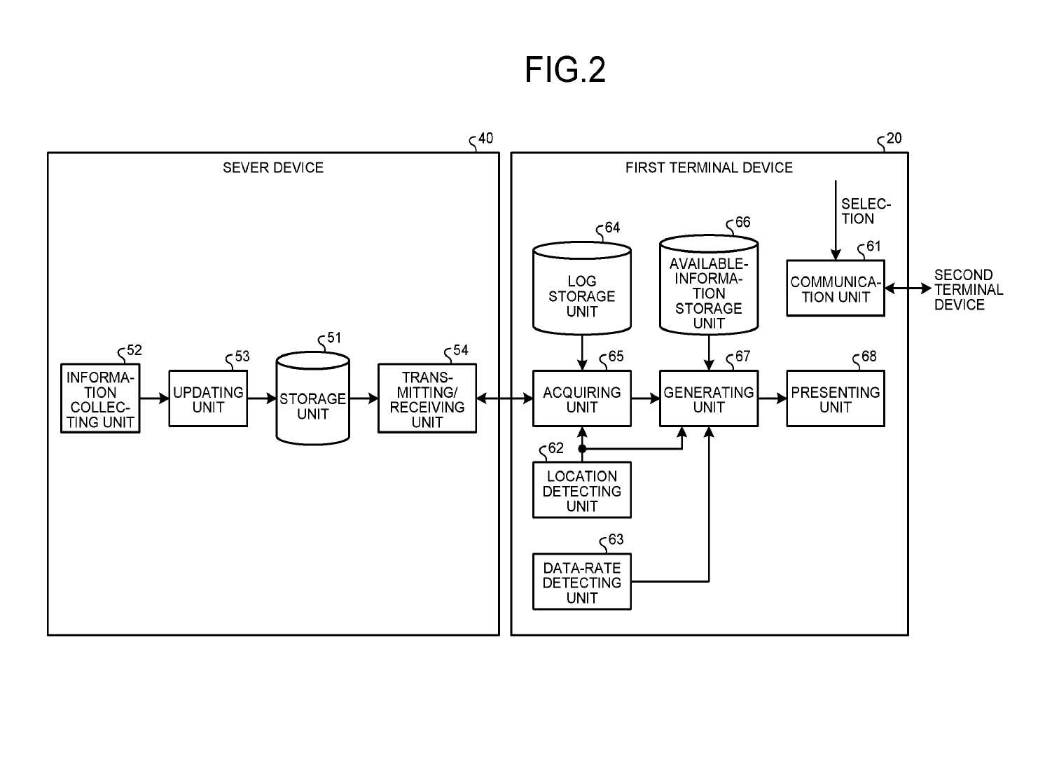

FIG. 2 is a diagram showing block configurations of the first terminal device 20 according to the first embodiment and the sever device 40. The sever device 40 includes a storage unit 51, an information collecting unit 52, an updating unit 53, and a transmitting/receiving unit 54.

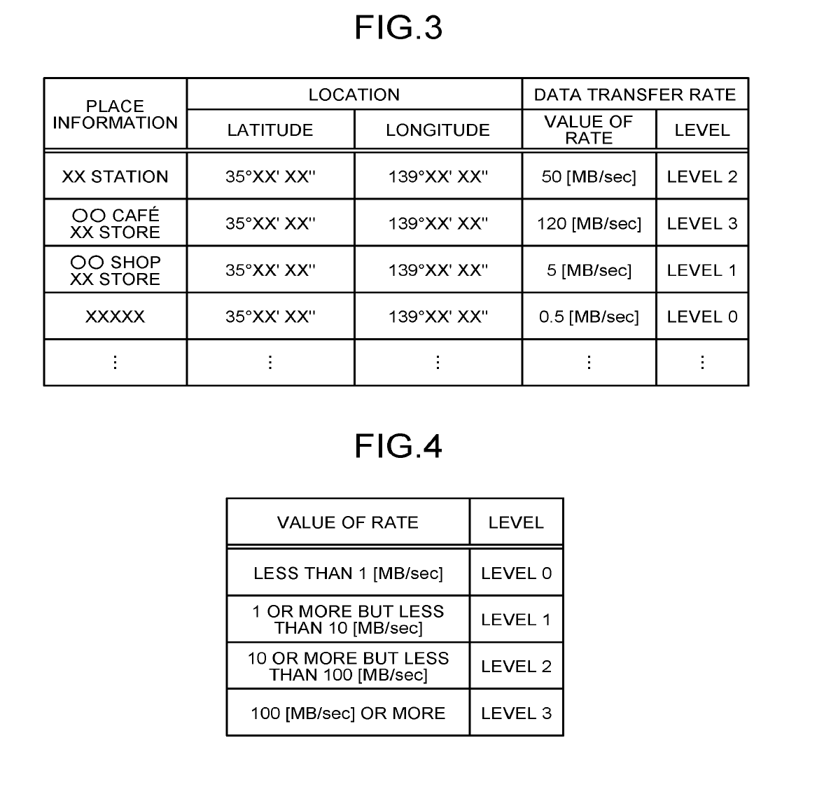

The storage unit 51 stores therein a table as shown in FIG. 3 that associates place information indicating a place with a location of the place and a data transfer rate when wireless communication is performed in the place. In PLACE INFORMATION, the name of a place such as a building, a facility, or a store is stored. In LOCATION, the longitude and latitude of the place is stored. In DATA TRANSFER RATE, a value of rate indicating the amount of transferred data per second when wireless communication is performed in the place is stored. If wireless communication can be performed in multiple communication forms in the place, a value of rate in a fastest communication form is stored in DATA TRANSFER RATE.

Furthermore, the storage unit 51 can store therein a data transfer rate of which the value is rounded to any of several ranks. In the present embodiment, the storage unit 51 stores therein a data transfer rate of which the value is rounded and expressed in any of four levels as shown in FIG. 4. More specifically, in the present embodiment, the storage unit 51 stores therein a data transfer rate of which the value is less than 1 [MB/sec] as “Level 0”, a data transfer rate of which the value is 1 [MB/sec] or more but less than 10 [MB/sec] as “Level 1”, a data transfer rate of which the value is 10 [MB/sec] or more but less than 100 [MB/sec] as “Level 2”, and a data transfer rate of which the value is 100 [MB/sec] or more as “Level 3”.

The information collecting unit 52 collects information of place information, location, and data transfer rate. As an example, the information collecting unit 52 collects information indicating setting places of wireless access points provided from a communications company. The information indicating setting places of wireless access points includes the name of a setting place of a wireless access point, a location (longitude and latitude), the fastest data transfer rate at the wireless access point, etc.

Furthermore, the information collecting unit 52 can collect, for example, real-time information indicating a real-time communication state and communication place of a communication device. The real-time information includes the name of a setting place of a wireless access point, a location (longitude and latitude) of the wireless access point, and the data transfer rate in actually-performed wireless communication.

Moreover, the information collecting unit 52 can collect, for example, written information indicating a communication state and communication place from multiple server devices on the network. For example, the information collecting unit 52 can collect information from a server etc. that provides a social networking service.

The updating unit 53 updates the table stored in the storage unit 51 on the basis of information collected by the information collecting unit 52. As an example, the updating unit 53 generates place information, a location, and a data transfer rate on the basis of a setting place of a wireless access point, real-time information, or written information collected by the information collecting unit 52, and stores the generated information in the storage unit 51.

The transmitting/receiving unit 54 receives a data acquisition request from the first terminal device 20, searches the storage unit 51 in accordance with the data acquisition request, and extracts place information, a location, and a data transfer rate. Then, the transmitting/receiving unit 54 sends the extracted place information, location, and data transfer rate to the first terminal device 20.

The first terminal device 20 includes a communication unit 61, a location detecting unit 62, a data-rate detecting unit 63, a log storage unit 64, an acquiring unit 65, an available-information storage unit 66, a generating unit 67, and a presenting unit 68.

The communication unit 61 receives selection of a communication form selected from multiple communication forms. Then, the communication unit 61 performs communication of information with the second terminal device 30 via the network in the selected communication form. In the present embodiment, the communication unit 61 communicates information with the second terminal device 30 via the network in one communication form selected from chat, IP telephony, and video conference.

The location detecting unit 62 detects the current location of the first terminal device 20. As an example, the location detecting unit 62 detects the longitude and latitude of the first terminal device 20.

The data-rate detecting unit 63 detects the data transfer rate when the first terminal device 20 performs wireless communication in the current location. As an example, the data-rate detecting unit 63 measures the communication sensitivity in the current location, and calculates a data transfer rate on the basis of the measured communication sensitivity. Furthermore, if wireless communication can be performed in multiple communication methods, the data-rate detecting unit 63 detects respective data transfer rates in the communication methods, and selects the maximum value.

Incidentally, the data-rate detecting unit 63 can detect a data transfer rate of which the value is rounded to any of several ranks just like the value stored in the storage unit 51. In the present embodiment, the data-rate detecting unit 63 detects a data transfer rate expressed in any of four levels as shown in FIG. 4.

The log storage unit 64 stores therein a log of a place where the first terminal device 20 performed wireless communication in the past, a location of the place where the first terminal device 20 performed wireless communication in the past, and a data transfer rate when the first terminal device 20 performed wireless communication in the place.

The acquiring unit 65 identifies a peripheral area of the current location of the first terminal device 20 on the basis of the current location detected by the location detecting unit 62. As an example, the acquiring unit 65 identifies an area within a predetermined distance from the current location as a peripheral area. The predetermined distance is, for example, an area of about a 10-minute walk (for example, within a range of 500 meters).

Then, the acquiring unit 65 acquires a communication-enabled place indicating a building, a facility, a store, or the like where the first terminal device 20 can communicate information in any of the communication forms in the identified peripheral area of the first terminal device 20, a location (longitude and latitude) of the communication-enabled place, and a data transfer rate when the first terminal device 20 performs wireless communication in the communication-enabled place.

For example, the acquiring unit 65 acquires the communication-enabled place in the peripheral area, the location, and the data transfer rate from the sever device 40 via the network. Specifically, the acquiring unit 65 accesses the server device 40 and issues a request for acquisition of a set of place information, a location, and a data transfer rate corresponding to a place of which the location is included in the peripheral area. When having received the acquisition request, the server device 40 extracts a corresponding set of place information, a location, and a data transfer rate from the storage unit 51, and sends the extracted information to the acquiring unit 65.

Alternatively, the acquiring unit 65 can acquire the communication-enabled place in the peripheral area, the location, and the data transfer rate from the log storage unit 64. Specifically, the acquiring unit 65 accesses the log storage unit 64 and extracts a set of place information, a location, and a data transfer rate corresponding to a place of which the location is included in the peripheral area.

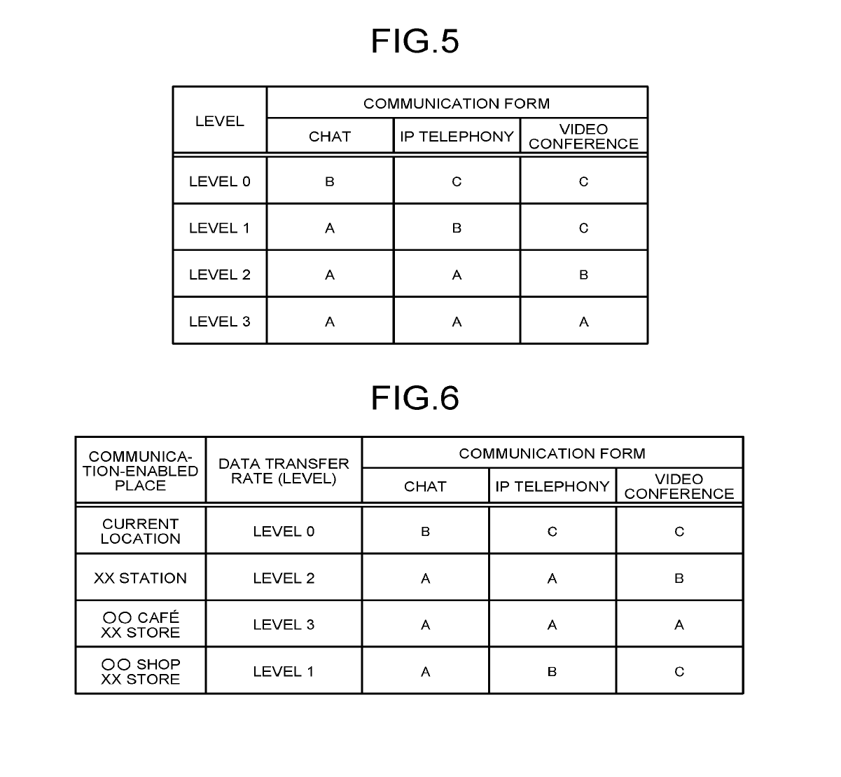

The available-information storage unit 66 stores therein available information indicating whether the communication forms are available at a corresponding data transfer rate with respect to each level of data transfer rate as shown in FIG. 5. In FIG. 5, available (A) is set when it is possible to communicate information at a corresponding data transfer rate, not available (C) is set it is not possible to communicate information, and unstable (B) is set when it may be possible to communicate information but the communicate is unstable.

For example, in an example of FIG. 5, available information at Level 0 (less than 1 [MB/sec]) is set that chat is unstable (B), IP telephony is not available (C), and video conference is not available (C). Furthermore, available information at Level 1 (1 [MB/sec] or more but less than 10 [MB/sec]) is set that chat is available (A), IP telephony is unstable (B), and video conference is not available (C). Moreover, available information at Level 2 (10 [MB/sec] or more but less than 100 [MB/sec]) is set that chat is available (A), IP telephony is available (A), and video conference is unstable (B). Furthermore, available information at Level 3 (100 [MB/sec] or more) is set that chat is available (A), IP telephony is available (A), and video conference is available (A).

Incidentally, the available information stored in the available-information storage unit 66 can differ according to the model or the installed program. For example, when a device is equipped with a sophisticated video coding decoder, if a moving image can be transmitted/received with the data highly compressed, the setting of video conference is available (A) even when the data transfer rate is relatively low.

The generating unit 67 generates available information indicating whether the communication forms are available on the basis of a corresponding data transfer rate with respect to each of the current location and communication-enabled places of the first terminal device 20 in the peripheral area. In the present embodiment, with respect to each of the current location and communication-enabled places of the first terminal device 20, the generating unit 67 extracts available information at a corresponding level of data transfer rate from the available-information storage unit 66.

For example, as shown in FIG. 6, with respect to the current location (Level 0), the generating unit 67 extracts available information set that chat is unstable (B), IP telephony is not available (C), and video conference is not available (C). Furthermore, for example, with respect to “XX Station” (Level 2), the generating unit 67 extracts available information set that chat is available (A), IP telephony is available (A), and video conference is unstable (B). Moreover, for example, with respect to “oo Café XX Store” (Level 3), the generating unit 67 extracts available information set that chat is available (A), IP telephony is available (A), and video conference is available (A). Furthermore, for example, with respect to “oo Shop XX Store” (Level 1), the generating unit 67 extracts available information set that chat is available (A), IP telephony is unstable (B), and video conference is not available (C).

The presenting unit 68 presents available information generated by the generating unit 67 with respect to each of the current location and communication-enabled places in the peripheral area to a user. In the present embodiment, the presenting unit 68 displays the available information on a display.

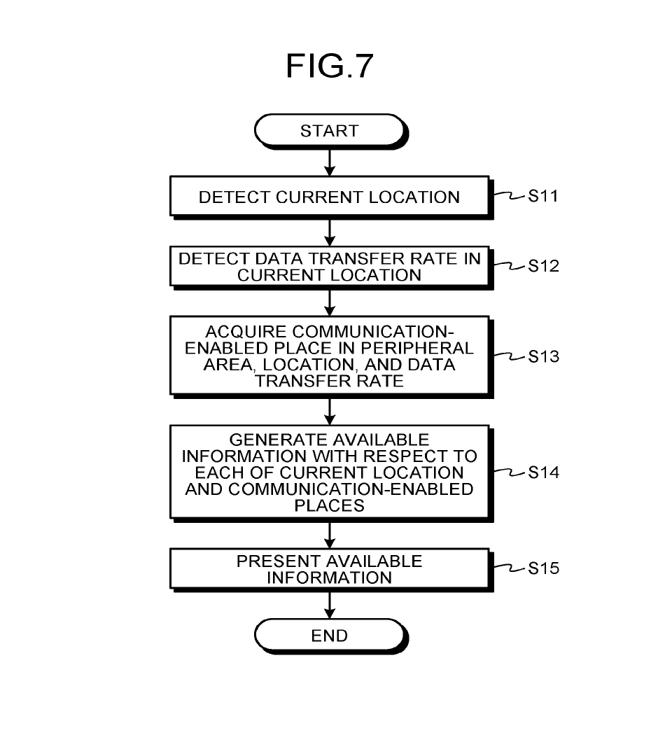

FIG. 7 is a flowchart showing a process performed by the first terminal device 20 according to the first embodiment. A processing procedure of the first terminal device 20 is explained below.

First, at Step S11, the location detecting unit 62 detects the current location of the first terminal device 20. Then, at Step S12, the data-rate detecting unit 63 detects the data transfer rate when the first terminal device 20 performs wireless communication in the current location.

Then, at Step S13, the acquiring unit 65 identifies a peripheral area of the first terminal device 20 on the basis of the detected current location. Then, the acquiring unit 65 acquires a communication-enabled place in the identified peripheral area, a location (longitude and latitude) of the communication-enabled place, and a data transfer rate when the first terminal device 20 performs wireless communication in the communication-enabled place. The acquiring unit 65 can acquire these pieces of information from the sever device 40 or the log storage unit 64.

Then, at Step S14, the generating unit 67 generates available information indicating whether the communication forms are available on the basis of a corresponding data transfer rate with respect to each of the current location and communication-enabled places in the peripheral area. In the present embodiment, with respect to each of the current location and communication-enabled places, the generating unit 67 extracts available information at a corresponding level of data transfer rate from the available-information storage unit 66.

Then, at Step S15, the presenting unit 68 presents the available information with respect to each of the current location and communication-enabled places in the peripheral area to a user. In the present embodiment, the presenting unit 68 displays the available information on the display.

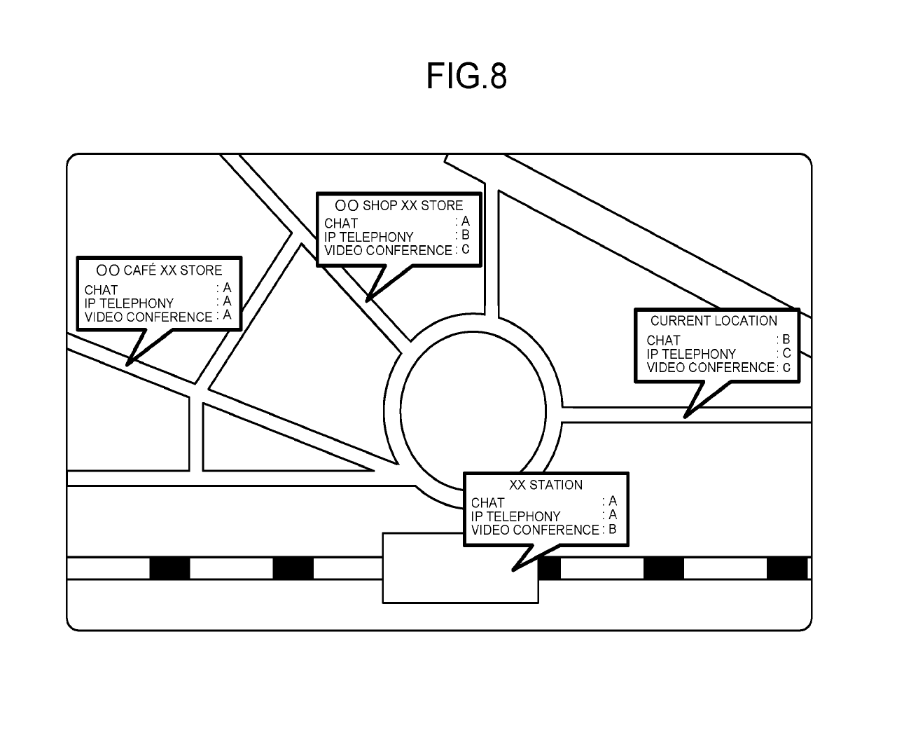

FIG. 8 is a diagram showing an example of display on the first terminal device 20 according to the first embodiment. In the present embodiment, the presenting unit 68 displays map information of the peripheral area on the display. Besides this, the presenting unit 68 displays available information in a position corresponding to a communication-enabled place on the map information (a position on a map corresponding to the longitude and latitude of the communication-enabled place).

For example, as shown in FIG. 8, the presenting unit 68 displays a balloon-like image in a position corresponding to a communication-enabled place on the map. Then, the presenting unit 68 displays a text indicating the corresponding communication-enabled place (a building, a facility, a store, or the like) and available information in the balloon-like image. Accordingly, the user of the first terminal device 20 can easily determine where to move to from the current location so as to communicate information with the second terminal device 30 in an intended communication form.

Furthermore, the presenting unit 68 can generate a text explaining a communication-enabled place and available communication forms in the communication-enabled place and display the generated text by voice output or text display. Accordingly, the user of the first terminal device 20 can determine where to move to from the current location so as to communicate information with the second terminal device 30 in the intended communication form without checking the map.

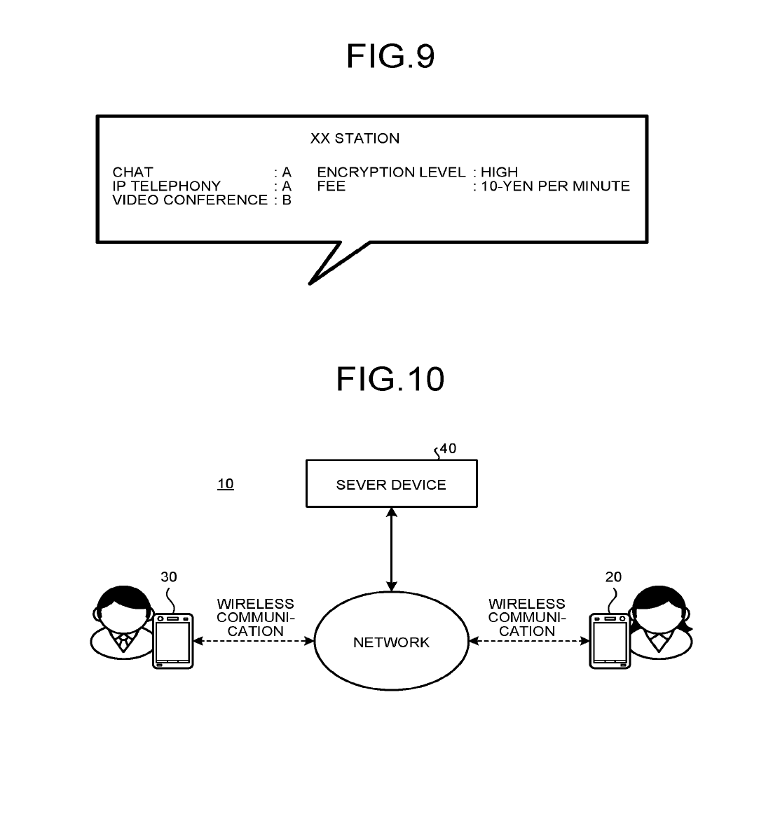

FIG. 9 is a diagram showing a display example of a balloon further including the security level and a communication fee. The presenting unit 68 can further display the security level and a communication fee in each communication-enabled place in the balloon as shown in FIG. 9.

The security level here indicates the encryption strength of communication. For example, the security level includes information on the presence or absence of a password, the type of the encryption strength, whether encryption of a communication path (for example, network formation by a virtual private network (VPN)) is possible or not, etc.

Incidentally, when the security level is displayed, the acquiring unit 65 acquires the security level when wireless communication is performed in a communication-enabled place from the sever device 40 or the log storage unit 64. Furthermore, when a communication fee is displayed, the acquiring unit 65 acquires a communication fee when wireless communication is performed in a communication-enabled place from the sever device 40 or the log storage unit 64.

Moreover, the presenting unit 68 can display information indicating the reliability of available information presented. For example, the presenting unit 68 can display information sources of collected communication-enabled places and data transfer rates. If a collected information source is information provided by a communications company, a user can determine that the information has high reliability. On the other hand, if a collected information source is information written in a social network server or the like, it can be determined that the information generally has lower reliability than information provided by a communications company. Also when such information indicating the reliability is displayed, the acquiring unit 65 acquires information indicating the reliability of information presented from the sever device 40 or the log storage unit 64.

Furthermore, the acquiring unit 65 can acquire information that an area in which wireless communication cannot be performed due to an accident, a disaster, or the like has arisen from the outside. In this case, the presenting unit 68 displays an area in which wireless communication cannot be performed on a map or the like, or presents this information to a user by text or voice output. Accordingly, the user can determine an area in which wireless communication cannot be performed in the peripheral area.

As described above, the communication system 10 according to the first embodiment can present where to move to so as to communicate information in an intended communication form to a user.

### Second Embodiment

Subsequently, a communication system 10 according to a second embodiment is explained. Incidentally, the communication system 10 according to the second embodiment is about the same as that in the first embodiment explained with reference to FIGS. 1 to 9, so a component having about the same function is assigned the same reference numeral and detailed description of the component is omitted, and differences from the first embodiment are mainly explained.

FIG. 10 is a diagram showing the communication system 10 according to the second embodiment. In the communication system 10 according to the second embodiment, the second terminal device 30 is a small-sized information processing apparatus carried by the second user. Therefore, the second terminal device 30 is connected to the network by wireless communication such as Wi-Fi™. Alternatively, the second terminal device 30 can be connected to the network by wireless communication complying with mobile communication standards such as LTE.

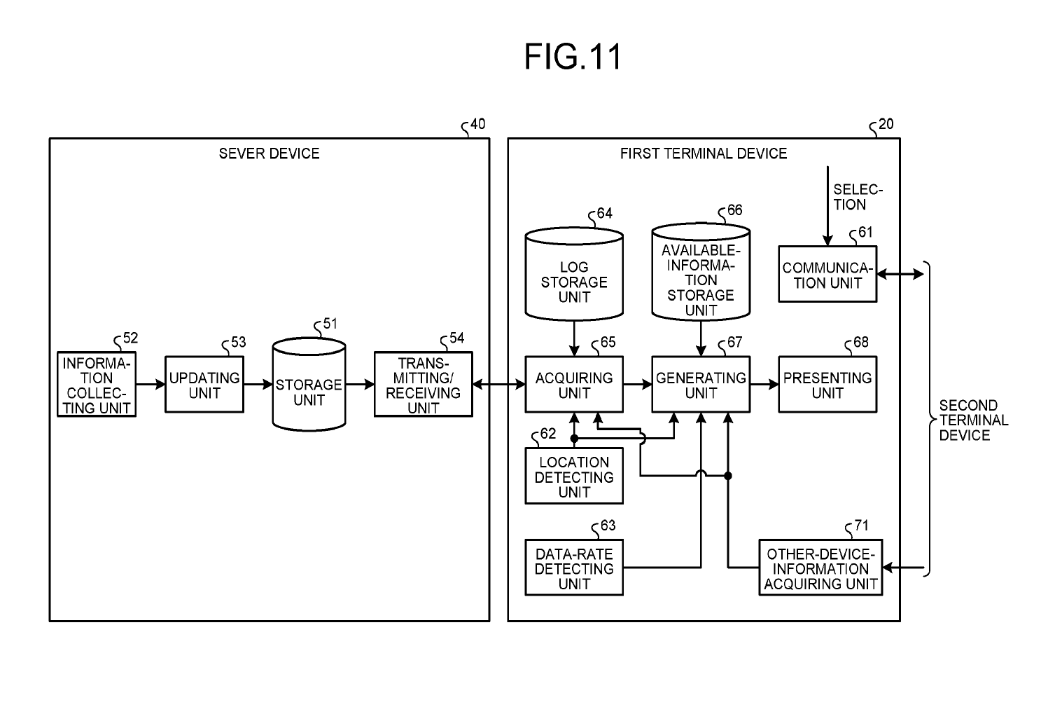

FIG. 11 is a diagram showing block configurations of the first terminal device 20 according to the second embodiment and the sever device 40. Incidentally, in the second embodiment, the second terminal device 30 (the other device) has the same functional configuration as the first terminal device 20, so description of the functional configuration is omitted.

The first terminal device 20 further includes an other-device-information acquiring unit 71. The other-device-information acquiring unit 71 receives the current location and data transfer rate of the second terminal device 30 from the second terminal device 30.

The acquiring unit 65 further identifies a peripheral area of the current location of the second terminal device 30 on the basis of the current location of the second terminal device 30 acquired by the other-device-information acquiring unit 71. Furthermore, the acquiring unit 65 further acquires a communication-enabled place in the identified peripheral area of the second terminal device 30, a location (longitude and latitude) of the communication-enabled place, and a data transfer rate when the second terminal device 30 performs wireless communication in the communication-enabled place.

The generating unit 67 generates available information on the basis of a corresponding data transfer rate with respect to each of the current location and communication-enabled places of the second terminal device 30 in the peripheral area. In the present embodiment, with respect to each of the current location and communication-enabled places of the second terminal device 30, the generating unit 67 extracts available information at a corresponding level of data transfer rate from the available-information storage unit 66.

The presenting unit 68 further presents available information with respect to each of the current location and communication-enabled places of the second terminal device 30 in the peripheral area to a user. In the present embodiment, the presenting unit 68 displays respective pieces of available information of the first terminal device 20 and the second terminal device 30 on the display.

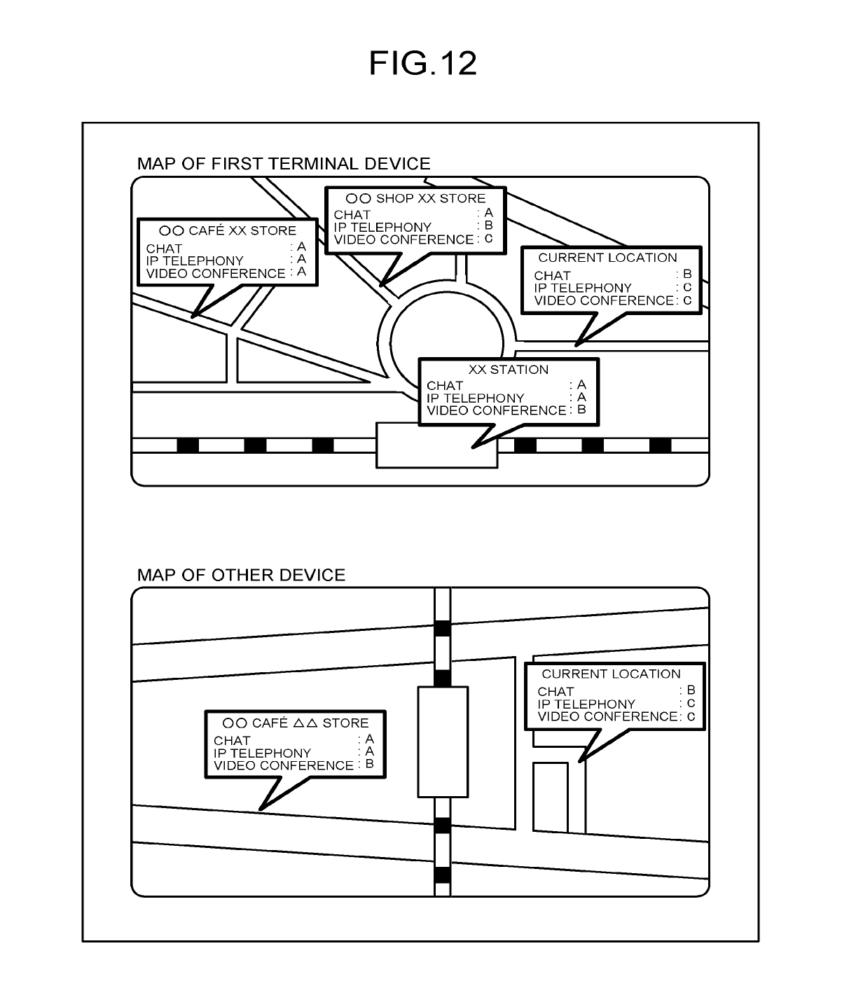

FIG. 12 is a diagram showing an example of display on the first terminal device 20 according to the second embodiment. The first terminal device 20 displays thereon, for example, two pieces of map information as shown in FIG. 12 (a map of the first terminal device 20 and a map of the other device) side by side. The map of the first terminal device 20 is map information indicating a peripheral area of the first terminal device 20. The map of the other device is map information indicating a peripheral area of the second terminal device 30.

Then, the presenting unit 68 displays a balloon in a position corresponding to a communication-enabled place on the map information indicating the peripheral area of the first terminal device 20, and displays available information in the corresponding communication-enabled place of the first terminal device 20 in the balloon. Furthermore, the presenting unit 68 displays a balloon in a position corresponding to a communication-enabled place on the map information indicating the peripheral area of the second terminal device 30, and displays available information in the corresponding communication-enabled place of the second terminal device 30 in the balloon.

Accordingly, the first user using the first terminal device 20 can determine where the second user is to move to so that the first terminal device 20 can communicate information with the second terminal device 30 in an intended communication form. Therefore, for example, even when the first user can easily move to a place where he/she can have a video conference, if the second user cannot move to a place where he/she can have the video conference, the first user can abandon selecting video conference.

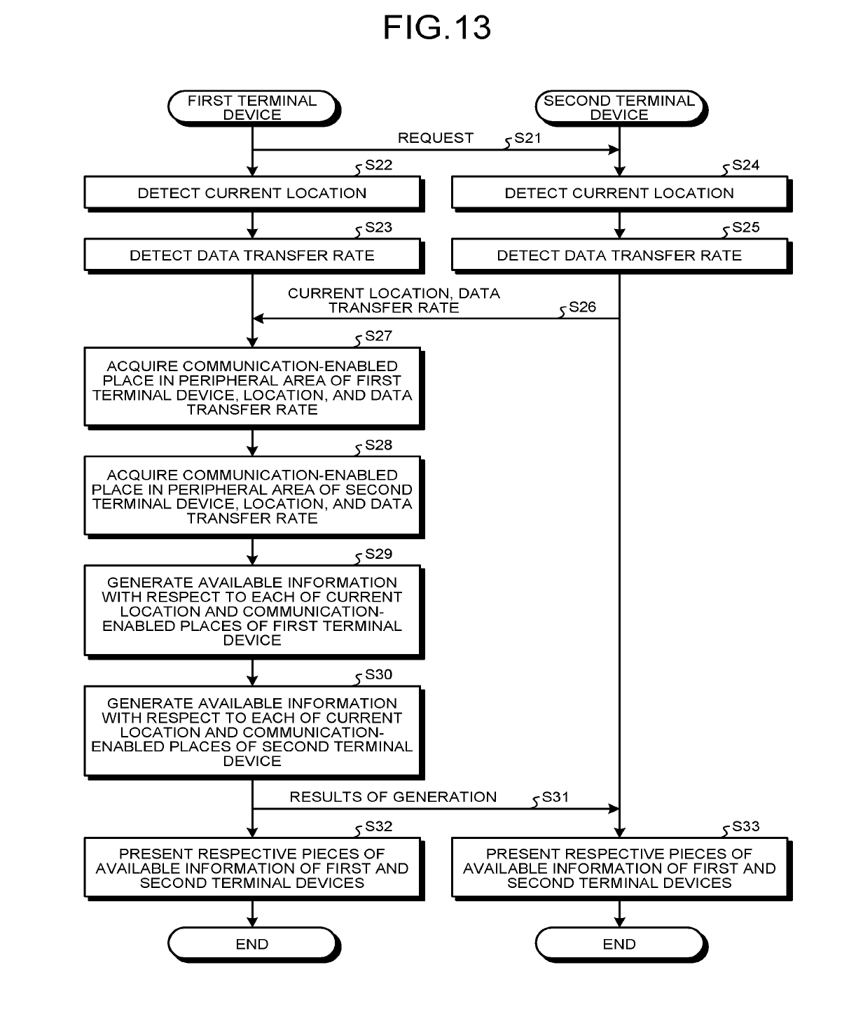

FIG. 13 is a flowchart showing a process performed by the first and second terminal devices 20 and 30 according to the second embodiment. A processing procedure of the first and second terminal devices 20 and 30 is explained below.

First, at Step S21, the first terminal device 20 sends a communication request to the second terminal device 30. Then, at Step S22, the first terminal device 20 detects the current location. Then, at Step S23, the first terminal device 20 detects the data transfer rate when the first terminal device 20 performs wireless communication in the current location.

On the other hand, when having received the communication request, the second terminal device 30 goes on the process from Step S24. At Step S24, the second terminal device 30 detects the current location. Then, at Step S25, the second terminal device 30 detects the data transfer rate when the second terminal device 30 performs wireless communication in the current location. Then, at Step S26, the second terminal device 30 sends the detected current location and data transfer rate to the first terminal device 20.

Then, when having received the current location and the data transfer rate from the second terminal device 30, the first terminal device 20 goes on the process from Step S27. At Step S27, the first terminal device 20 identifies a peripheral area of the first terminal device 20 on the basis of the detected current location of the first terminal device 20. Then, the first terminal device 20 acquires a communication-enabled place in the identified peripheral area of the first terminal device 20, a location of the communication-enabled place, and a data transfer rate when the first terminal device 20 performs wireless communication in the communication-enabled place.

Then, at Step S28, the first terminal device 20 identifies a peripheral area of the second terminal device 30 on the basis of the received current location of the second terminal device 30. Then, the first terminal device 20 acquires a communication-enabled place in the identified peripheral area of the second terminal device 30, a location of the communication-enabled place, and a data transfer rate when the second terminal device 30 performs wireless communication in the communication-enabled place.

Then, at Step S29, the first terminal device 20 generates available information on the basis of a corresponding data transfer rate with respect to each of the current location and communication-enabled places of the first terminal device 20 in the peripheral area.

Then, at Step S30, the first terminal device 20 generates available information on the basis of a corresponding data transfer rate with respect to each of the current location and communication-enabled places of the second terminal device 30 in the peripheral area.

Then, at Step S31, the first terminal device 20 sends results of the generation at Steps S29 and S30 to the second terminal device 30. That is, the first terminal device 20 sends the place information, location, and available information with respect to each of the respective current locations and communication-enabled places of the first and second terminal devices 20 and 30 in the peripheral areas to the second terminal device 30.

Then, at Step S32, the first terminal device 20 displays thereon the available information with respect to each of the respective current locations and communication-enabled places of the first and second terminal devices 20 and 30 in the peripheral areas. For example, the first terminal device 20 displays thereon an image as shown in FIG. 12.

Then, when having received the available information, the second terminal device 30 performs a process at Step S33. At Step S33, the second terminal device 30 displays thereon the available information with respect to each of the respective current locations and communication-enabled places of the first and second terminal devices 20 and 30 in the peripheral areas. For example, the second terminal device 30 displays thereon the same information as that displayed on the first terminal device 20.

Incidentally, the processes at Steps S28 and S30 can be performed by not the first terminal device 20 but the second terminal device 30. In this case, the second terminal device 30 does not perform the process at Step S26, and, after the process at Step S30, the second terminal device 30 sends the available information with respect to each of the current location and communication-enabled places of the second terminal device 30 in the peripheral area to the first terminal device 20. Furthermore, in this case, at Step S31, the first terminal device 20 sends the available information with respect to each of the current location and communication-enabled places of the first terminal device 20 in the peripheral area to the second terminal device 30.

The communication system 10 according to the above-described second embodiment can present where to move to so as to communicate information in an intended communication form to both users of the first and second terminal devices 20 and 30.

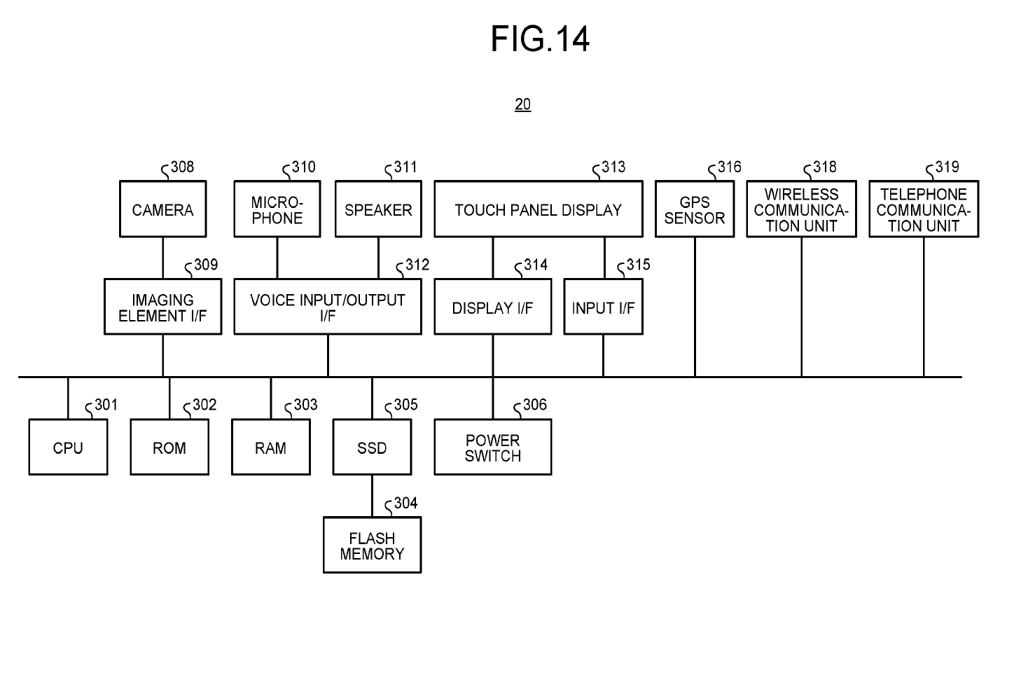

FIG. 14 is a diagram showing a hardware configuration of the first terminal device 20. Incidentally, the second terminal device 30 has the same hardware configuration as the first terminal device 20.

The first terminal device 20 includes a CPU 301, a ROM 302, a RAM 303, a flash memory 304, an SSD 305, a power switch 306, a camera 308, an imaging element I/F 309, a microphone 310, a speaker 311, a voice input/output I/F 312, a touch panel display 313, a display I/F 314, an input I/F 315, a global positioning system (GPS) sensor 316, a wireless communication unit 318, and a telephone communication unit 319.

The CPU 301 controls the entire operation of the first terminal device 20. The ROM 302 stores therein a program used to drive the CPU 301. The RAM 303 is used as a work area of the CPU 301. The flash memory 304 stores therein a program of the first terminal device 20 and various data such as image data and voice data. The first terminal device 20 can include an EEPROM or the like instead of the flash memory 304. The SSD 305 controls reading data out from the flash memory 304 or writing data into the flash memory 304 in accordance with the control by the CPU 301. The power switch 306 is a button for switching the power to the first terminal device 20 on/off.

The camera 308 takes an image of an object and obtains image data in accordance with the control by the CPU 301. The imaging element I/F 309 controls driving of the camera 308. The microphone 310 inputs voice. The speaker 311 outputs voice. The voice input/output I/F 312 processes input/output of a voice signal between the microphone 310 and the speaker 311 in accordance with the control by the CPU 301.

The touch panel display 313 displays thereon an image according to image data, operation icons, etc. Furthermore, the touch panel display 313 receives an operation input made on a screen thereof. The display I/F 314 transmits image data to the touch panel display 313 in accordance with the control by the CPU 301. The input I/F 315 detects an operation input to the touch panel display 313.

The GPS sensor 316 detects radio waves from a GPS satellite, thereby detecting a location (longitude and latitude) of the first terminal device 20. The wireless communication unit 318 connects to a network by wireless communication such as Wi-Fi™. The telephone communication unit 319 connects to a network by wireless communication complying with a mobile communication standard such as LTE. These components are connected via a bus line.

A program executed by the first terminal device 20 according to the present embodiment is composed of modules including a communication module, a location detecting module, a data-rate detecting module, an acquiring module, a generating module, and a presenting module. This program is expanded onto the RAM 303 and executed by the CPU 301 (a processor), thereby making an information processing apparatus serve as the communication unit 61, the location detecting unit 62, the data-rate detecting unit 63, the acquiring unit 65, the generating unit 67, and the presenting unit 68. Furthermore, this program makes a storage device such as the flash memory 304 serve as the log storage unit 64 and the available-information storage unit 66.

Incidentally, the configuration of the first terminal device 20 is not limited to this, and at least some of the communication unit 61, the location detecting unit 62, the data-rate detecting unit 63, the acquiring unit 65, the generating unit 67, and the presenting unit 68 can be realized by a hardware circuit (for example, a semiconductor integrated circuit).

The program executed by the first terminal device 20 according to the present embodiment is provided in such a manner that the program is recorded on a computer-readable recording medium, such as a CD-ROM, a flexible disk (FD), a CD-R, or a digital versatile disk (DVD), in an installable or executable file format.

Furthermore, the program executed by the first terminal device 20 according to the present embodiment can be provided in such a manner that the program is stored on a computer connected to a network such as the Internet so that a user can download it via the network. Moreover, the program executed by the first terminal device 20 according to the present embodiment can be provided or distributed via a network such as the Internet. Furthermore, the program executed by the first terminal device 20 can be built into the ROM or the like in advance.

According to the embodiments of the present invention, it is possible to present where to move to so as to communicate information in an intended communication form to a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

The present invention can be implemented in any convenient form, for example using dedicated hardware, or a mixture of dedicated hardware and software. The present invention may be implemented as computer software implemented by one or more network processing apparatus. The network can comprise any conventional terrestrial or wireless communications network, such as the Internet. The processing apparatus can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implemental on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. A terminal device that is carried by a user and is connected to a network by wireless communication, the terminal device comprising:
a communication unit that communicates information with some other device via the network in a communication form selected from multiple communication forms;
an acquiring unit that acquires a communication-enabled place where the terminal device can communicate information in any of the communication forms in a peripheral area of a current location of the terminal device and a data transfer rate when the terminal device performs wireless communication in the communication-enabled place;
a generating unit that generates available information indicating whether the communication forms are available on the basis of a corresponding data transfer rate with respect to each communication-enabled place in the peripheral area; and
a presenting unit that presents the available information in each communication-enabled place in the peripheral area to the user.

2. The terminal device according to claim 1, wherein
the communication unit performs communication of information with the other device in a communication form selected from communication of information using text, communication of information using voice, and communication of information using moving image.

3. The terminal device according to claim 1, further comprising a data-rate detecting unit that detects a data transfer rate when the terminal device performs wireless communication in the current location, wherein
the generating unit further generates available information on the basis of the corresponding data transfer rate with respect to the current location, and
the presenting unit further presents the available information in the current location to the user.

4. The terminal device according to claim 1, wherein
the presenting unit displays map information of the peripheral area on a display, and displays the available information in a position corresponding to each communication-enabled place on the map information.

5. The terminal device according to claim 1, wherein
the presenting unit generates a text explaining each communication-enabled place and available communication forms in the communication-enabled place, and displays the generated text by voice output or text display.

6. The terminal device according to claim 1, wherein
the acquiring unit acquires the communication-enabled place in the peripheral area and the data transfer rate from a server device, which has stored therein place information indicating a place and a data transfer rate when wireless communication is performed in the place, via the network.

7. The terminal device according to claim 1, further comprising a log storage unit that stores therein a log of a place where the terminal device performed wireless communication in the past and a data transfer rate when the terminal device performed wireless communication in the place, wherein
the acquiring unit acquires the communication-enabled place in the peripheral area and the data transfer rate from the log storage unit.

8. The terminal device according to claim 1, wherein
the acquiring unit further acquires security level when the terminal device performs wireless communication in each communication-enabled place, and
the presenting unit further presents the security level in the communication-enabled place to the user.

9. The terminal device according to claim 1, wherein
the acquiring unit further acquires a communication fee when the terminal device performs wireless communication in each communication-enabled place, and
the presenting unit further presents the communication fee in the communication-enabled place to the user.

10. The terminal device according to claim 1, further comprising an other-device-information receiving unit that receives a current location of the other device from the other device used by a communication partner, wherein
the acquiring unit further acquires a communication-enabled place and data transfer rate in a peripheral area of the current location of the other device,
the generating unit further generates available information on the basis of a corresponding data transfer rate with respect to each of the current location and communication-enabled places in the peripheral area of the current location of the other device, and
the presenting unit further presents the available information with respect to each of the current location and communication-enabled places in the peripheral area of the current location of the other device to the user.

11. The terminal device according to claim 1, further comprising an other-device-information receiving unit that receives a communication-enabled place in a peripheral area of the other device and available information in the communication-enabled place from the other device from the other device used by a communication partner, wherein
the presenting unit further presents the available information of the other device with respect to each communication-enabled place in the peripheral area of the other device to the user.

12. A communication system comprising:
a first terminal device that is carried by a first user and is connected to a network by wireless communication;
a second terminal device that is used by a second user who is a partner for communication with the first user; and
a sever device that is accessed by the first terminal device via the network, wherein
the first terminal device includes:
a communication unit that communicates information with the second terminal device via the network in a communication form selected from multiple communication forms;
an acquiring unit that acquires a communication-enabled place where the first terminal device can communicate information in any of the communication forms in a peripheral area of a current location of the first terminal device and a data transfer rate when the first terminal device performs wireless communication in the communication-enabled place;
a generating unit that generates available information indicating whether the communication forms are available on the basis of a corresponding data transfer rate with respect to each communication-enabled place in the peripheral area; and
a presenting unit that presents the available information in each communication-enabled place in the peripheral area to the user.

13. The communication system according to claim 12, wherein
the sever device includes a storage unit that stores therein place information indicating a place and a data transfer rate when wireless communication is performed in the place, and
the acquiring unit acquires the communication-enabled place in the peripheral area and the data transfer rate from the server device via the network.

14. The communication system according to claim 13, wherein
the server device further includes:
an information collecting unit that collects information indicating setting places of wireless access points; and
an updating unit that generates place information on a place and a data transfer rate when wireless communication is performed in the place on the basis of the collected setting places of wireless access points and stores the generated information in the storage unit.

15. The communication system according to claim 13, wherein
the server device further includes:
an information collecting unit that collects real-time information indicating a real-time communication state and communication place of a communication device; and
an updating unit that generates place information on a place and a data transfer rate when wireless communication is performed in the place on the basis of the real-time communication and stores the generated information in the storage unit.

16. The communication system according to claim 13, wherein
the server device further includes:
an information collecting unit that collects written information indicating a communication state and communication place from multiple server devices on the network; and
an updating unit that generates place information on a place and a data transfer rate when wireless communication is performed in the place on the basis of the written communication and stores the generated information in the storage unit.

17. A method implemented by a terminal device that is carried by a user and is connected to a network by wireless communication, the terminal device being capable of communicating information with some other device via the network in a communication form selected from multiple communication forms, the method comprising:
acquiring a communication-enabled place where the terminal device can communicate information in any of the communication forms in a peripheral area of a current location of the terminal device and a data transfer rate when the terminal device performs wireless communication in the communication-enabled place;
generating available information indicating whether the communication forms are available on the basis of a corresponding data transfer rate with respect to each communication-enabled place in the peripheral area; and
presenting the available information in each communication-enabled place in the peripheral area to the user.
